(19) United States
(12) Patent Application Publication
(10) Pub. No.: US 2014/0295193 A1
(43) Pub. Date: Oct. 2, 2014

(54) POLYESTER POLYOL RESINS COMPOSITIONS

(71) Applicant: Momentive Specially Chemicals Inc., Columbus, OH (US)

(72) Inventors: Denis Heymans, Ottignies-Louvain-la-Neuve (BE); Christophe Steinbrecher, Ottignies-Louvain-la-Neuve (BE); Cédric Le Fevere De Ten Hove, Ottignies-Louvain-la-Neuve (BE)

(73) Assignee: Momentive Specialty Chemicals Inc., Columbus, OH (US)

(21) Appl. No.: 14/352,264

(22) PCT Filed: Oct. 16, 2012
(86) PCT No.: PCT/EP2012/004322

§ 371 Date: Apr. 16, 2014

(30) Foreign Application Priority Data
Oct. 19, 2011 (EP) 11075234.2
Apr. 5, 2012 (EP) 12002495.5

(51) Int. Cl. C08G 63/00; C09D 7/12; C08F 8/46; C08F 8/00; C08G 63/78; C08L 67/00

(52) U.S. Cl. CPC C08G 63/00; C08G 63/78; C08L 67/00; C08F 8/46; C08F 8/00; C09D 7/125
USPC 428/458; 528/297; 525/176; 525/384; 524/513; 428/480

(57) ABSTRACT

The invention relates to compositions of polyester polyol resins comprising a mixture of α,α-branched alkane carboxylic acids glycidyl esters with a defined isomeric composition where the sum of the concentration of the blocked and of the highly branched isomers is at least 50%, preferably above 60% and most preferably above 75% on total composition.

The present invention relates to a composition of polyester polyol resins comprising a mixture of α,α-branched alkane carboxylic glycidyl esters derived from butene oligomers characterized in that the sum of the concentration of the blocked and of the highly branched isomers is at least 50%, preferably above 60% and most preferably above 75% on total composition.

More in particular the invention relates to polyester polyol resins compositions comprising of aliphatic tertiary saturated carboxylic acids or α,α-branched alkane carboxylic acids, which contain 9 or 13 carbon atoms and which provide glycidyl esters with a branching level of the alkyl groups depending on the olefin feedstock used and/or the oligomerization process thereof, and which is defined as below.

The purity of the glycidyl ester prepared from neo acids was found to have an influence on the glass temperature transition of the resin derived from, this was obtained by a flash distillation according to U.S. Pat. No. 6,136,991.

The modifications of polyester resins by Cardura 10 or Cardura 5 were illustrated in WO 96/20968.

However, the industry is still interested in glycidyl ester derived from butene oligomers with chemical composition leading to high hardness of the coating and maintaining the overall good performance.

It is generally known from e.g. U.S. Pat. No. 2,831,877, U.S. Pat. No. 2,876,241, U.S. Pat. No. 3,053,869, U.S. Pat. No. 2,967,873 and U.S. Pat. No. 3,061,621 that mixtures of α,α-branched alkane carboxylic acids can be produced, starting from mono-olefins, such as butenes and isomers such as isobutene or butene dimer, trimer or oligomer, carbon monoxide and water, in the presence of a strong acid.

The glycidyl esters can be obtained according to PCT/EP2010/003334 or U.S. Pat. No. 6,433,217.

We have discovered that well chosen blend of isomers of the glycidyl ester of, for example, neononanoic acids give different and unexpected performance in combination with some particular polymers such as polyester polyols.

The ratio between primary and secondary hydroxyl can be modulated as given in WO 01/25225.

The isomers are described in Table 1 and illustrated in Scheme 1.

We have found that the performance of the glycidyl ester compositions derived from the branched acid is depending on the branching level of the alkyl groups R¹, R² and R³, for example the neononanoic acid has 3, 4 or 5 methyl groups. Highly branched isomers are defined as isomers of neo-acids having at least 5 methyl groups.

Neo-acids, for example neononanoic acids (V9) with a secondary or a tertiary carbon atoms in the β position are defined as blocking isomers.

Mixture compositions of neononanoic acids glycidyl esters providing for example a high hardness of a coating, is a mixture where the sum of the concentration of the blocked and of the highly branched isomers is at least 50%, preferably above 60% and most preferably above 75% on total composition.

The composition of the glycidyl ester mixture is comprising 2,2-dimethyl 3,3-dimethyl pentanoic acid glycidyl ester or 2-methyl 2-isopropyl 3-methyl butanoic acid glycidyl ester or 2-methyl 2-ethyl 3,3-dimethyl butanoic acid glycidyl ester.

The composition of the glycidyl ester mixture is comprising 2,2-dimethyl 3-methyl 4-methyl pentanoic acid glycidyl ester and 2,2-dimethyl 4,4-dimethyl pentanoic acid glycidyl ester.

The composition of the glycidyl ester mixture in which the sum of the following content of glycidyl ester mixture, comprising 2,2-dimethyl 3,3-dimethyl pentanoic acid glycidyl ester and 2-methyl 2-isopropyl 3-methyl butanoic acid glycidyl ester and 2-methyl 2-ethyl 3,3-dimethyl butanoic acid glycidyl ester, is above 10% weight, preferably above 15% weight and most preferably above 25% weight on total composition.

The composition of the glycidyl ester mixture in which the sum of the following content of glycidyl ester mixture, comprising 2,2-dimethyl 3,3-dimethyl pentanoic acid glycidyl ester and 2-methyl 2-isopropyl 3-methyl butanoic acid glycidyl ester and 2-methyl 2-ethyl 3,3-dimethyl butanoic acid glycidyl ester and 2,2-dimethyl 3-methyl 4-methyl pentanoic acid glycidyl ester and 2,2-dimethyl 4,4-dimethyl pentanoic acid glycidyl ester, is above 40% weight, preferably above 50% weight and most preferably above 60% weight on total composition.

The composition of the glycidyl ester mixture in which the content of 2-methyl 2-ethyl hexanoic acid glycidyl ester is below 40% weight, preferably below 30% weight and most preferably below 20% weight on total composition.

The composition of the glycidyl ester mixture in which the glycidyl ester mixture is comprising 2,2-dimethyl 3,3-dimethyl pentanoic acid glycidyl ester in 1 to 99 weight % or 2-methyl 2-isopropyl 3-methyl butanoic acid glycidyl ester in 1 to 99 weight % or 2-methyl 2-ethyl 3,3-dimethyl butanoic acid glycidyl ester in 1 to 99 weight % on total composition.

A preferred composition of the glycidyl ester mixture in which the glycidyl ester mixture is comprising 2,2-dimethyl 3,3-dimethyl pentanoic acid glycidyl ester in 2 to 50 weight % or 2-methyl 2-isopropyl 3-methyl butanoic acid glycidyl ester in 5 to 50 weight % or 2-methyl 2-ethyl 3,3-dimethyl butanoic acid glycidyl ester in 3 to 60 weight % on total composition.

A further preferred composition of the glycidyl ester mixture in which the glycidyl ester mixture is comprising 2,2-dimethyl 3,3-dimethyl pentanoic acid glycidyl ester in 3 to 40 weight % or 2-methyl 2-isopropyl 3-methyl butanoic acid glycidyl ester in 10 to 35 weight % or 2-methyl 2-ethyl 3,3-dimethyl butanoic acid glycidyl ester in 5 to 40 weight % on total composition.

The composition of the glycidyl ester mixture in which the glycidyl ester mixture is comprising 2,2-dimethyl 3-methyl 4-methyl pentanoic acid glycidyl ester in 1 to 99 weight % or 2,2-dimethyl 4,4-dimethyl pentanoic acid glycidyl ester in 0.1 to 99 weight %.

A preferred composition of the glycidyl ester mixture in which the glycidyl ester mixture is comprising 2,2-dimethyl 3-methyl 4-methyl pentanoic acid glycidyl ester in 2 to 50 weight % or 2,2-dimethyl 4,4-dimethyl pentanoic acid glycidyl ester in 0.1 to 80 weight %.

A further preferred composition of the glycidyl ester mixture in which the glycidyl ester mixture is comprising 2,2-dimethyl 3-methyl 4-methyl pentanoic acid glycidyl ester in 4 to 25 weight % or 2,2-dimethyl 4,4-dimethyl pentanoic acid glycidyl ester in 0.2 to 45 weight %.

The above glycidyl esters compositions can be used for example, as reactive diluent or as monomer in binder compositions for paints or adhesives.

The glycidyl esters compositions can be used as reactive diluent for epoxy based formulations such as exemplified in the technical brochure of Momentive (Product Bulletin: Cardura E10P The Unique Reactive Diluent MSC-521).

Other uses of the glycidyl ester are the combinations with polyester polyols, or acrylic polyols, or polyether polyols. The combination with polyester polyols such as the one used in the car industry coating leads to a fast drying coating system with attractive coating properties, like increase hardness.

### Methods Used

The isomer distribution of neo-acid can be determined using gas chromatography, using a flame ionization detector (FID). 0.5 ml sample is diluted in analytical grade dichloromethane and n-octanol may be used as internal standard. The conditions presented below result in the approximate retention times given in Table 1. In that case n-octanol has a retention time of approximately 8.21 minute.

The GC method has the following settings:

Column: CP Wax 58 CB (FFAP), 50 m×0.25 mm, df=0.2 μm

Oven program: 150° C. (1.5 min)-3.5° C./min-250° C. (5 min)=35 min

Carrier gas: Helium

Flow: 2.0 mL/min constant

Split flow: 150 mL/min

Split ratio: 1:75

Injector temp: 250° C.

Detector temp: 325° C.

Injection volume: 1 μL

CP Wax 58 CB is a Gas chromatography column available from Agilent Technologies.

The isomers of neononanoic acid as illustrative example have the structure (R¹R²R³)—C—COOH where the three R groups are linear or branched alkyl groups having together a total of 7 carbon atoms.

The structures and the retention time, using the above method, of all theoretical possible neononanoic isomers are drawn in Scheme 1 and listed in Table 1.

The isomers content is calculated from the relative peak area of the chromatogram obtained assuming that the response factors of all isomers are the same.

TABLE 1
Structure of all possible neononanoic isomers

| | | | | Methyl | | Retention time |
|---|---|---|---|---|---|---|
| | R1 | R2 | R3 | groups | Blocking | [Minutes] |
| V901 | Methyl | Methyl | n-pentyl | 3 | No | 8.90 |
| V902 | Methyl | Methyl | 2-pentyl | 4 | Yes | 9.18 |
| V903 | Methyl | Methyl | 2-methyl butyl | 4 | No | 8.60 |
| V904 | Methyl | Methyl | 3-methyl butyl | 4 | No | 8.08 |
| V905 | Methyl | Methyl | 1,1-dimethyl propyl | 5 | Yes | 10.21 |
| V906 | Methyl | Methyl | 1,2-dimethy propyl | 5 | Yes | 9.57 |
| V907 | Methyl | Methyl | 2,2-dimethyl propyl | 5 | No | 8.26 |
| V908 | Methyl | Methyl | 3-pentyl | 4 | Yes | 9.45 |
| V909 | Methyl | Ethyl | n-butyl | 3 | No | 9.28 |
| V910 K1 | Methyl | Ethyl | s-butyl | 4 | Yes | 9.74 |
| V910 K2 | Methyl | Ethyl | s-butyl | 4 | Yes | 9.84 |
| V911 | Methyl | Ethyl | i-butyl | 4 | No | 8.71 |
| V912 | Methyl | Ethyl | t-butyl | 5 | Yes | 9.64 |
| V913 | Methyl | n-propyl | n-propyl | 3 | No | 8.96 |
| V914 | Methyl | n-propyl | i-propyl | 4 | Yes | 9.30 |
| V915 | Methyl | i-propyl | i-propyl | 5 | Yes | 9.74 |
| V916 | Ethyl | Ethyl | n-propyl | 3 | No | 9.44 |
| V917 | Ethyl | Ethyl | i-propyl | 4 | Yes | 10.00 |

The isomer distribution of glycidyl esters of neo-acid can be determined by gas chromatography, using a flame ionization detector (FID). 0.5 ml sample is diluted in analytical grade dichloromethane.

The GC method has the following settings:

Column: CP Wax 58 CB (FFAP), 50 m×0.2 mm, df=0.52 μm

Oven: 175° C. (5 min)-1° C./min-190° C. (0 min)-10° C./min-275° C. (11.5 min)

Flow: 2.0 mL/min, constant flow

Carrier gas: Helium

Split ratio: 1:75

Injection volume: 1 μL

S/SL injector: 250° C.

CP Wax 58 CB is a Gas chromatography column available from Agilent Technologies.

The isomers of glycidyl esters of neononanoic acid as illustrative example have the structure (R¹R²R³)—C—COO—CH₂—CH(O)CH₂ where the three R groups are linear or branched alkyl groups having together a total of 7 carbon atoms.

The isomers content is calculated from the relative peak area of the chromatogram obtained assuming that the response factors of all isomers are the same.

GC-MS method can be used to identify the various isomers providing that the analysis is done by a skilled analytical expert.

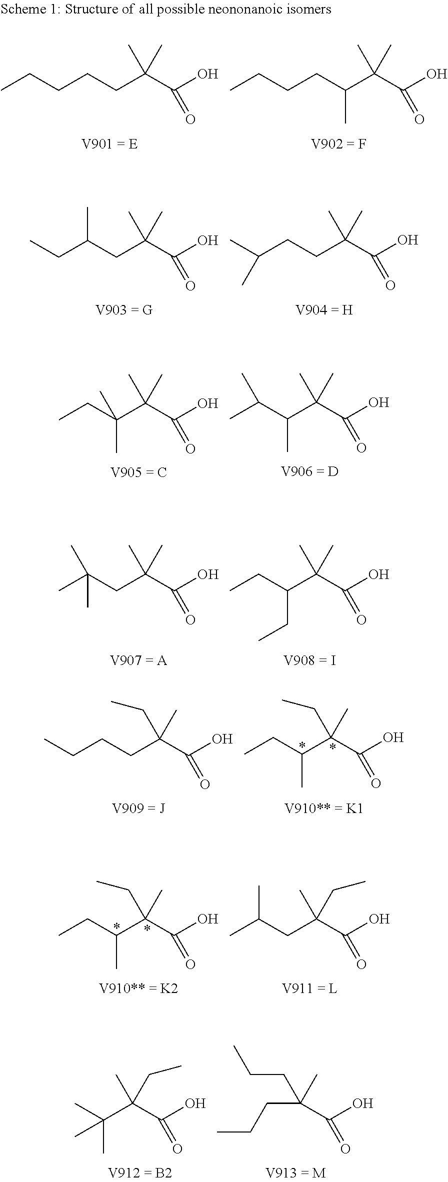

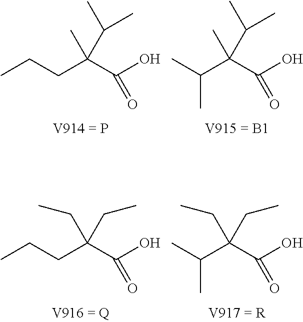

### Methods for the Characterization of the Resins

The molecular weights of the resins are measured with gel permeation chromatography (Perkin Elmer/Water) in THF solution using polystyrene standards. Viscosity of the resins are measured with Brookfield viscometer (LVDV-I) at indicated temperature. Solids content are calculated with a function (Ww-Wd)/Ww×100%. Here Ww is the weight of a wet sample, Wd is the weight of the sample after dried in an oven at a temperature 110° C. for 1 hour.

Tg (glass transition temperature) has been determined either with a DSC 7 from Perkin Elmer or with an apparatus from TA Instruments Thermal Analysis. Scan rates were respectively 20 and 10° C./min. Only data obtained in the same experimental conditions have been compared. If not, the temperature difference occurring from the different scanning rate has been proved not significant for the results compared.

### Blocking Isomers

Whereas the carbon atom in alpha position of the carboxylic acid is always a tertiary carbon atom, the carbon atom(s) in β position can either be primary, secondary or tertiary. Neononanoic acids (V9) with a secondary or a tertiary carbon atoms in the β position are defined as blocking (blocked) isomers (Schemes 2 and 3).

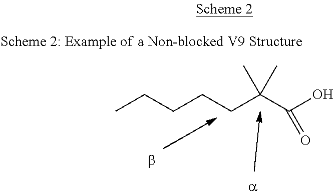

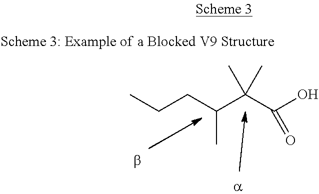

The use of the glycidyl esters compositions, discussed here above, can be as monomer in binder compositions for paints and adhesives. These binders can be based on a polyester polyol resin comprising the above glycidyl composition.

The polyester polyol resins of the invention are based on a composition of hydroxyl functional polyester resins (polyester polyols, oligoester polyols) comprising a mixture of α,α-branched alkane carboxylic glycidyl esters derived from butene oligomers characterized in that the sum of the concentration of the blocked and of the highly branched isomers is at least 50%, preferably above 60% and most preferably above 75% on total composition.

A preferred composition is that the glycidyl ester mixture is based on neononanoic (C9) acid mixture where the sum of the concentration of the blocked and of the highly branched isomers is at least 50%, preferably above 60% and most preferably above 75% on total composition.

Further the neononanoic (C9) glycidyl ester mixture is comprising 2,2-dimethyl 3,3-dimethyl pentanoic acid glycidyl ester or 2-methyl 2-isopropyl 3-methyl butanoic acid glycidyl ester or 2-methyl 2-ethyl 3,3-dimethyl butanoic acid glycidyl ester.

Another embodiment is that the composition of the glycidyl ester mixture is comprising 2,2-dimethyl 3-methyl 4-methyl pentanoic acid glycidyl ester or 2,2-dimethyl 4,4-dimethyl pentanoic acid glycidyl ester.

A further embodiment is that the composition of the glycidyl ester mixture is comprising the sum of the following content of glycidyl ester mixture, comprising 2,2-dimethyl 3,3-dimethyl pentanoic acid glycidyl ester and 2-methyl 2-isopropyl 3-methyl butanoic acid glycidyl ester and 2-methyl 2-ethyl 3,3-dimethyl butanoic acid glycidyl ester, is above 10% weight, preferably above 15% weight and most preferably above 25% weight on total composition.

A further embodiment is that the composition of the glycidyl ester mixture is comprising the sum of the following content of glycidyl ester mixture, comprising 2,2-dimethyl 3,3-dimethyl pentanoic acid glycidyl ester and 2-methyl 2-isopropyl 3-methyl butanoic acid glycidyl ester and 2-methyl 2-ethyl 3,3-dimethyl butanoic acid glycidyl ester and 2,2-dimethyl 3-methyl 4-methyl pentanoic acid glycidyl ester and 2,2-dimethyl 4,4-dimethyl pentanoic acid glycidyl ester, is above 40% weight, preferably above 50% weight and most preferably above 60% weight on total composition.

A further embodiment is that the composition of the glycidyl ester mixture is comprising 2-methyl 2-ethyl hexanoic acid glycidyl ester is below 40% weight, preferably below 30% weight and most preferably below 20% weight on total composition.

A further embodiment is that the composition of the glycidyl ester mixture is comprising 2,2-dimethyl 3,3-dimethyl pentanoic acid glycidyl ester in 1 to 99 weight % or 2-methyl 2-isopropyl 3-methyl butanoic acid glycidyl ester in 1 to 99 weight % or 2-methyl 2-ethyl 3,3-dimethyl butanoic acid glycidyl ester in 1 to 99 weight % on total composition and a prefer is in that the glycidyl ester mixture is comprising 2,2-dimethyl 3,3-dimethyl pentanoic acid glycidyl ester in 2 to 50 weight % or 2-methyl 2-isopropyl 3-methyl butanoic acid glycidyl ester in 5 to 50 weight % or 2-methyl 2-ethyl 3,3-dimethyl butanoic acid glycidyl ester in 3 to 60 weight % on total composition, and a most prefer composition is that the glycidyl ester mixture is comprising 2,2-dimethyl 3,3-dimethyl pentanoic acid glycidyl ester in 3 to 40 weight % or 2-methyl 2-isopropyl 3-methyl butanoic acid glycidyl ester in 10 to 35 weight % or 2-methyl 2-ethyl 3,3-dimethyl butanoic acid glycidyl ester in 5 to 40 weight % on total composition.

A further embodiment is that the composition of the glycidyl ester mixture is comprising 2,2-dimethyl 3-methyl 4-methyl pentanoic acid glycidyl ester in 1 to 99 weight % or 2,2-dimethyl 4,4-dimethyl pentanoic acid glycidyl ester in 0.1 to 99 weight %, a preferred composition is that the glycidyl ester mixture is comprising 2,2-dimethyl 3-methyl 4-methyl pentanoic acid glycidyl ester in 2 to 50 weight % or 2,2-dimethyl 4,4-dimethyl pentanoic acid glycidyl ester in 0.1 to 80 weight %, and a most prefer composition is that the glycidyl ester mixture is comprising 2,2-dimethyl 3-methyl 4-methyl pentanoic acid glycidyl ester in 4 to 25 weight % or 2,2-dimethyl 4,4-dimethyl pentanoic acid glycidyl ester in 0.2 to 45 weight %.

The process to prepare the compositions of the polyester polyol resin is obtained by the reaction of a polycarboxylic acid compound and a mixture of the α,α-branched alkane carboxylic glycidyl esters, in which the polycarboxylic acid compound can be for example obtained by the polycondensation reaction of one or more multifunctional polyol with one or more anhydride or acid anhydride.

The glycidyl ester could be derived from the above glycidyl ester composition.

The polycarboxylic acid compound can be selected from for example: phthalic, isophthalic, terephthalic, succinic, adipic, azelaic, sebacic, tetrahydrophthalic, hexahydrophthalic, HET, maleic, fumaric, itaconic, and trimellitic acids or any polycarboxylic acid derived from below indicated anhydrides or any mixture of these compounds.

The multifunctional polyol can be selected from for example: trimethylolpropane, ditrimethylolpropane, pentaerythritol, dipentaerythritol, tripentaerythritol, neopentyl glycol, glycerine, ethyleneglycol, cyclohexane dimethylol 1,4, mannitol, xylitol, isosorbide, erythritol, sorbitol, ethylene glycol, 1,2-propylene glycol, 1,2-butylene glycol, 2,3-butylene glycol, 1,2-hexanediol, 1,2-dihydroxycyclohexane, 3-ethoxypropane-1,2-diol and 3-phenoxypropane-1,2-diol; neopentyl glycol, 2-methyl-1,3-propanediol, 2-methyl-2,4-pentanediol, 3-methyl-1,3-butane diol, 2-ethyl-1,3-hexanediol, 2,2-diethyl-1,3-propanediol, 2,2,4-trimethyl-1,3-pentanediol, 2-butyl-2-ethyl-1,3-propanediol, 2-phenoxypropane-1,3-diol, 2-methyl-2-phenylpropane-1,3-diol, 1,3-propylene glycol, 1,3-butylene glycol, 2-ethyl-1,3-octanediol, 1,3-dihydroxycyclohexane, 1,4-butanediol, 1,4-dihydroxycyclohexane, 1,5-pentanediol, 1,6-hexanediol, 2,5-hexanediol, 3-methyl-1,5-pentanediol, 1,4-dimethylolcyclohexane, tricyclodecanedimethanol, 2,2-dimethyl-3-hydroxypropyl-2,2-dimethyl-3-hydroxypropyonate (an esterification product of hydroxy-pivalic acid with neopentyl glycol), 2,2,4-Trimethyl-1,3-pentanediol (TMPD), mixture of 1,3- and 1,4-cyclohexanedimethanol (=Unoxol diol ex Dow Chemicals), bisphenol A, bisphenol F, bis(4-hydroxyhexyl)-2,2-propane, bis(4-hydroxyhexyl)methane, 3,9-bis(1,1-dimethyl-2-hydroxyethyl)-2,4,8,10-tetroxaspiro[5,5]-undecane, di-ethylene glycol, triethylene glycol, glycerine, diglycerine, triglycerine, trimethylol-ethane and tris(2-hydroxyethyl)isocyanurate. Either pure multifunctional polyol can be used or mixtures of at least two of them.

The anhydride or acid anhydride can be selected from for example: succinic anhydride, maleic anhydride, phthalic anhydride, hexahydrophthalic anhydride, methylhexahydrophthalic anhydride, trimellitic anhydride, hydrogenated trimellitic anhydride, 1,2-cyclopentanedicarboxylic anhydride, tetrahydrophthalique anhydride, methyl tetrahydrophthalic anhydride,5-norbornene-2,3-dimethyl hydrogenated 5-norbornene-2,3-dicarboxilic anhydride, methyl-5-norbornene-2,3-dicarboxylic anhydride, hydrogenated methyl-5-norbornene-2,3-dicarboxylic anhydride, the Diels-Alder adduct of maleic anhydride with sorbic acid, the hydrogenated Diels-Alder adduct of maleic anhydride and sorbic acid. Either pure anhydride or acid anhydride can be used or mixtures of at least two of them. Commercially available product as Epikure 866, Epikure 854, Epikure 868 or Epikure 878 (all ex Momentive Specialty Chemicals Inc.) can be used as such or in mixture with the above given anhydrides or acids anhydrides.

The polyester polyol resins of the invention prepared according to the above processes will have a calculated hydroxyl value between 40 and 320 mgKOH/g on solid and the number average molecular weight (Mn) is between 500 and 7000 Dalton according polystyrene standard.

The polyester polyol resins of the invention prepared according to the above processes will have the acid value of the polyester polyol resin lower than 20 mg KOH/g on solids resins and preferably lower than 10 mg KOH/g on solids resins, most prefer lower than 6.

A further process to prepare the composition as described above wherein the polyester polyol is made from α,α-branched alkane carboxylic glycidyl esters.

A further process to prepare the composition the polyester polyol resin is made in the presence of an excess of α,α-branched alkane carboxylic glycidyl esters.

The invention is also related to a binder composition useful for coating composition comprising at least any hydroxyl functional polyester resins as prepared above.

The said binder compositions are suitable for coating metal or plastic substrates. The polyester resin prior cured will be characterized by his glass transition temperature (Tg), which is for instance between 40 and 50° C. These resins when formulated in a curable composition will lead to hard cured films with a higher Tg.

Binders based on the above compositions are especially suitable for a fast drying coating to be applied on an automotive substrate.

### EXAMPLES

### Chemicals Used

Cardura™ E10: available from Momentive Specialty Chemicals

Neononanoic glycidyl ester from Momentive Specialty Chemicals

GE9S: neononanoic glycidyl ester of composition A (see Table 2)

GE9H: neononanoic glycidyl ester of composition B (see Table 2)

Neononanoic glycidyl ester of composition C (see Table 2)

Neononanoic glycidyl ester of composition D (see Table 2)

Neononanoic glycidyl ester of composition E (see Table 2)

TABLE 2
Composition of the neononanoic glycidyl ester
(according to the described gas chromatography
method for glycidyl esters of neo-acid)

Glycidyl ester of acid V9XX
(described in Table 1)

| | A (%) | B (%) | C (%) | D (%) | E (%) |
|---|---|---|---|---|---|
| V901 | 6.5 | 0.1 | 3.7 | 0.1 | 0.1 |
| V902 | 0.6 | 2.55 | 0.6 | 2.4 | 2.65 |
| V903 | 1.1 | 0.7 | 0.3 | 1.0 | 0.4 |
| V904 | 0.8 | 1 | 0.1 | 2.2 | 0.4 |
| V905 | 0.2 | 13.1 | 0.5 | 4.1 | 14.5 |
| V906 | 0.4 | 11.6 | 0.4 | 9.6 | 12.6 |
| V907 | 0.2 | 15.4 | 0.1 | 36.4 | 5.6 |
| V908 | 0.1 | 0 | 0.1 | 0.0 | 0.0 |
| V909 | 54.8 | 2.55 | 52.8 | 2.4 | 2.65 |
| V910 K1 | 7.8 | 0 | 10.0 | 0.0 | 0.0 |
| V910 K2 | 7.7 | 0.6 | 12.8 | 0.4 | 0.7 |
| V911 | 2.4 | 1.2 | 0.7 | 2.0 | 0.8 |
| V912 | 0.0 | 28.3 | 0.0 | 22.4 | 33.5 |
| V913 | 6.8 | 0.1 | 6.4 | 0.1 | 0.1 |
| V914 | 4.5 | 0 | 3.8 | 0.0 | 0.0 |
| V915 | 0.6 | 22.3 | 0.6 | 16.8 | 25.3 |
| V916 | 4.4 | 0.1 | 5.2 | 0.1 | 0.1 |
| V917 | 1.1 | 0.4 | 2.1 | 0.1 | 0.4 |

GE5: glycidyl ester of pivalic acid obtained by reaction of the acid with epichlorhydrin.

Ethylene glycol from Aldrich

Monopentaerythritol: available from Sigma-Aldrich

3,3,5 Trimethyl cyclohexanol: available from Sigma-Aldrich

Maleic anhydride: available from Sigma-Aldrich

Methylhexahydrophtalic anhydride: available from Sigma-Aldrich

Hexahydrophtalic anhydride: available from Sigma-Aldrich

Boron trifluoride diethyl etherate (BF3.OEt2) from Aldrich

Acrylic acid: available from Sigma-Aldrich

Methacrylic acid: available from Sigma-Aldrich

Hydroxyethyl methacrylate: available from Sigma-Aldrich

Styrene: available from Sigma-Aldrich

2-Ethylhexyl acrylate: available from Sigma-Aldrich

Methyl methacrylate: available from Sigma-Aldrich

Butyl acrylate: available from Sigma-Aldrich

Di-t-Amyl Peroxide is Luperox DTA from Arkema

tert-Butyl peroxy-3,5,5-trimethylhexanoate: available from Akzo Nobel

Xylene

n-Butyl Acetate from Aldrich

Dichloromethane from Biosolve

Thinner: A: is a mixture of Xylene 50 wt %, Toluene 30 wt %, ShellsolA 10 wt %, 2-Ethoxyethylacetate 10 wt %. Thinner B: is butyl acetate

Curing agents, HDI: 1,6-hexamethylene diisocyanate trimer, Desmodur N3390 BA from Bayer Material Science or Tolonate HDT LV2 from Perstorp

Leveling agent: ‘BYK 10 wt %’ which is BYK-331 diluted at 10% in butyl acetate

Catalyst: ‘DBTDL 1 wt %’ which is Dibutyl Tin Dilaurate diluted at 1 wt % in butyl acetate

Catalyst: ‘DBTDL 10 wt %’ which is Dibutyl Tin Dilaurate diluted at 10 wt % in butyl acetate

### Example 01

### Comparative

The following constituents were charged to a reaction vessel: 0.7153 grams of a neononanoic glycidyl ester of composition C, 0.5958 grams of hexahydro-4-methylphthalic anhydride, 0.0014 grams of ethylene glycol. The reaction took place for 3 to 4 days at 140° C. The sample has been dried by evaporation. The polyester had a molecular weight (Mn) of 4700 Daltons and a Tg of +18.8° C.

### Example 02

The following constituents were charged to a reaction vessel: 0.5823 grams of a neononanoic glycidyl ester of composition D, 0.4775 grams of hexahydro-4-methylphthalic anhydride, 0.0011 grams of ethylene glycol, 0.2841 grams of n-Butyl Acetate. The reaction took place for 3 to 4 days at 120-140° C. and the solvent was then thoroughly removed by evaporation. The polyester had a molecular weight (Mn) of 5000 Daltons and a Tg of +43.7° C.

### Example 03

The following constituents were charged to a reaction vessel: 0.5846 grams of a neononanoic glycidyl ester of composition E, 0.4786 grams of hexahydro-4-methylphthalic anhydride, 0.0011 grams of ethylene glycol, 0.2847 grams of n-Butyl Acetate. The reaction took place for 3 to 4 days at 120-140° C. and the solvent was then thoroughly removed by evaporation. The polyester had a molecular weight (Mn) of 3800 Daltons and a Tg of +48.1° C.

Observations:

Tg of polyesters is impacted by the composition of the neononanoic glycidyl ester (see examples 01, 02, 03).

The resins of the examples can be formulated in coating compositions such as 2K (polyurethane) with a low VOC (volatile organic compound) level and still providing and excellent appearance.

### Example 04

### Comparative

Monopentaerythritol, methylhexahydrophthalic anhydride and n-Butyl Acetate (see 1°/in Table 3) were charged to a reaction vessel and heated at 140° C. until complete conversion. Cardura E10P (see 1°/in Table 3) was then dropwise added and the reaction pursued until acceptable acid value. The polyester had a solid content of 76.0 wt %. At a suitable temperature, Cardura E10P and xylene (see 2°/in Table 3) were then added. The mixture was heated to about 157° C. and the monomers, radical initiator and solvent (see 3°/in Table 3) were fed for 6 hours at that temperature. A post-cooking (1 h) then took place with additional radical initiator (see 4°/in Table 3). After further addition of n-butyl acetate (see 5°/in Table 3), the final resin had a solid content of 66.2 wt %.

### Example 05

Recipe of example 04 was used with the amount indicated in Table 3 while using GE9H instead of Cardura E10P for the polyester cooking. The intermediate polyester and the final resin had a solid content of 78.4 wt % and 66.8 wt %, respectively.

### Example 06

Recipe of example 05 was used with the amount indicated in Table 3 while using GE9H instead of Cardura E10P for the acrylic polyol cooking. The intermediate polyester and the final resin had a solid content of 78.4 wt % and 68.3 wt %, respectively.

TABLE 3
Constituents for the polyester based acrylic polyol cooking

| Example | Example | Example |
|---|---|---|
| 04 | 05 | 06 |

1°/Polyester cooking, constituent (g)

| | | | |
|---|---|---|---|
| Monopentaerythritol | 4.0 | 4.2 | 3.4 |
| Methylhexahydrophthalic | 15.2 | 15.9 | 12.7 |
| anhydride | | | |
| n-Butyl acetate | 10.0 | 10.4 | 8.3 |
| Cardura E10P | 22.3 | | |
| GE9H | | 21.9 | 17.5 |

2°/Acrylic polyol cooking, initial reactor charge (g)

| | | | |
|---|---|---|---|
| Polyester (from above) | 51.5 | 52.3 | 41.8 |
| Cardura E10P | 33.2 | 31.3 | — |
| GE9H | — | — | 24.9 |
| Xylene | 3.6 | 3.4 | 2.9 |

3°/Acrylic polyol cooking, feeding material (g)

| | | | |
|---|---|---|---|
| Acrylic Acid | 9.5 | 9.0 | 7.6 |
| Hydroxyethyl methacrylate | 23.9 | 22.5 | 19.0 |
| Styrene | 39.8 | 37.5 | 31.7 |
| Butyl Acrylate | 0.0 | 0.0 | 0.8 |
| Methyl methacrylate | 26.3 | 24.8 | 21.6 |
| Xylene | 11.0 | 10.4 | 8.8 |
| Di-t-Amyl Peroxide | 5.3 | 5.0 | 4.2 |

4°/Acrylic polyol post cooking, feeding material (g)

| | | | |
|---|---|---|---|
| Di-t-Amyl Peroxide | 1.3 | 1.3 | 1.1 |

5°/Acrylic polyol solid content adjustment, solvent adding (g)

| | | | |
|---|---|---|---|
| n-Butyl acetate | 55.7 | 52.6 | 44.4 |

Formulation of the Clear Coats

A clear coat is formulated with one of the polyester based acrylic polyol (from examples 04, 05 or 06, the curing agent (HDI, Desmodur N3390), the thinner, the levelling agent (BYK-331) and the catalyst (dibutyltin dilaurate, DBTDL) according to the amounts indicated in Table 4.

TABLE 4
Clear coats, formulations

| | | | | BYK 10 | DBTDL | |
|---|---|---|---|---|---|---|
| CE- | Binder | Binder | HDI | wt % | 1 wt % | Thinner A |
| Example | (ID) | (g) | (g) | (g) | (g) | (g) |
| CE-04 | From | 92.1 | 34.7 | 0.67 | 1.47 | 37.2 |
| | Example | | | | | |
| | 04 | | | | | |
| CE-05 | From | 91.3 | 36.0 | 0.66 | 1.46 | 37.4 |
| | Example | | | | | |
| | 05 | | | | | |
| CE-06 | From | 91.3 | 36.9 | 0.68 | 1.50 | 39.7 |
| | Example | | | | | |
| | 06 | | | | | |

### Characterization of the Clear Coats

The clearcoat formulations (from Table 5) are applied with a barcoater on degreased Q-panel. The panels are dried at room temperature, optionally with a preliminary stoving at 60° C. for 30 min. Clear coats have been characterized among others by measuring the dust free time and Koenig hardness development (see Table 5).

TABLE 5
Clear coats, drying (curing) properties

| | | |
|---|---|---|
| CE-04 | CE-05 | CE-06 |

1°/Dust free time (Room temperature drying panels) (min)

| | | | |
|---|---|---|---|
| Dust free time (min) | 39 | 35 | 24 |

2°/Koenig Hardness (Room temperature drying panels) (sec)

| | | | |
|---|---|---|---|
| 6 hours | 3 | 4 | 7 |
| 24 hours | 31 | 38 | 49 |
| 7 days | 156 | 167 | 179 |

3°/Koenig Hardness (Stoved Q panels) (sec)

| | | | |
|---|---|---|---|
| Out of the oven | 12 | 15 | 24 |
| 6 hours | 15 | 18 | 29 |
| 24 hours | 48 | 55 | 67 |
| 7 days | 178 | 180 | 190 |

Observation (see Table 5): significant improvement (lower dust free time and quicker hardness development) is observed when replacing Cardura E10P by GE9H for the polyester cooking. Improvement is even more significant when Cardura E10P is complementary replaced by GE9H for the acrylic polyol cooking.

### Example 07

### Comparative

### Monopentaerythritol/Methylhexahydrophtalic Anhydride/GE9S (1/3/3 Molar Ratio)=CE-GE9S

80.4 g amount of butylacetate, 68.3 g of monopentaerythritol, 258.2 g of methylhexahydrophthalic anhydride are loaded in a glass reactor and heated to reflux until complete dissolution. Afterwards, the temperature is decreased down to 120° C. and 333.0 g of GE9S are added over about one hour. The cooking is pursued at 120° C. for the time needed to decrease epoxy group content and acid value down to an acid value below 15 mg KOH/g. Then, further 82.4 g of butylacetate are added. Test results are indicated in Table 6.

### Example 08

### Trimethylolpropane/Hexahydrophtalic Anhydride/GE9H (1/2/2 Molar Ratio)

30.2 g amount of butylacetate, 31.6 g of trimethylolpropane, 70.3 g of hexahydrophthalic anhydride and 1.3 g of a DBTDL 10 wt % are loaded in a glass reactor and heated to reflux until complete dissolution. Afterwards, the temperature is decreased down to 120° C. and 104.8 g of GE9H are added over about one hour. The cooking is pursued at 120° C. for the time needed to decrease epoxy group content and acid value down to an acid value below 15 mg KOH/g. Then, further 20.0 g of butylacetate are added.

### Example 09

### Monopentaerythritol/Methylhexahydrophtalic Anhydride/GE9H (1/3/3 Molar Ratio)=CE-GE9Ha

80.4 g amount of butylacetate, 68.3 g of monopentaerythritol, 258.2 g of methylhexahydrophthalic anhydride are loaded in a glass reactor and heated to reflux until complete dissolution. Afterwards, the temperature is decreased down to 120° C. and 337.1 g of GE9H are added over about one hour. The cooking is pursued at 120° C. for the time needed to decrease epoxy group content and acid value down to an acid value below 15 mg KOH/g. Then, further 83.4 g of butylacetate are added. Test results are indicated in Table 6.

### Example 10

### Monopentaerythritol/Methylhexahydrophtalic Anhydride/GE9H (1/3/3 Molar Ratio)=CE-GE9Hb

CE-GE9Hb is a duplication of Example 09 performed in very close experimental conditions.

### Example 11

### Comparative According to EP 0996657

### Monopentaerythritol/Methylhexahydrophtalic Anhydride/GE5 (1/3/3 Molar Ratio) CE-GE5a

71.3 g amount of butylacetate, 60.5 g of monopentaerythritol, 228.90 g of methylhexahydrophthalic anhydride are loaded in a glass reactor and heated to reflux until complete dissolution. Afterwards, the temperature is decreased down to 120° C. and 214.3 g of GE5 are added over about one hour. The cooking is pursued at 120° C. for the time needed to decrease epoxy group content and acid value down to an acid value below 15 mg KOH/g. Then, further 52.1 g of butylacetate are added. Test results are indicated in Table 6.

### Example 12

### Comparative According to EP 0996657

### Monopentaerythritol/Methylhexahydrophtalic Anhydride/GE5 (1/3/3 Molar Ratio) CE-GE5b

CE-GE5b is a duplication of comparative example 11 performed in very close experimental conditions except for the higher amount of butylacetate added at the end of the reaction.

TABLE 6
Polyesters characterization

| | SC | Mw | Mn | Mw/Mn | Viscosity | |
|---|---|---|---|---|---|---|
| Polyester resin | (%) | (Da) | (Da) | (PDI) | (cP) | |
| CE-GE9S | 78.6 | 974 | 919 | 1.06 | 2450 | (25.9° C.) |
| CE-GE9Ha | 80.0 | 921 | 877 | 1.05 | 6220 | (25.9° C.) |
| CE-GE9Hb | 80.0 | 1014 | 975 | 1.04 | 11740 | (21.6° C.) |
| CE-GE5a | 79.3 | 914 | 886 | 1.03 | 5080 | (26.0° C.) |
| CE-GE5b | 68.3 | 1177 | 1122 | 1.05 | 102.3 | (22.0° C.) |

SC: solids content

### Example 13

### Comparative

Acrylic Resin Synthesis

Cardura™ E10 based acrylic polyol resin: Acryl-CE(10)

105.0 g amount of CE10 (Cardura™ E10-glycidyl ester of Versatic acid) and 131.6 g of Shellsol A are loaded in a glass reactor and heated up to 157.5° C. Then, a mixture of monomers (37.4 g acrylic acid, 107.9 g hydroxyethyl methacrylate, 180.0 g styrene, 100.2 g butyl acrylate, 69.6 g methyl methacrylate) and initiator (12.0 g Di-tert-butyl peroxide) is fed into the reactor at a constant rate in 5 hours. Then post cooking started: a mixture of 6.0 g Di-tert-butyl peroxide and 18.0 g n-butyl acetate is fed into the reactor at a constant rate in 0.5 hour, then temperature maintained at about 157.5° C. for a further 0.5 hour. Finally, 183.2 g of n-butyl acetate is added under stirring to achieve a polyol resin with the target solids content. Test results are indicated in Table 7.

TABLE 7
Acryl-CE(10) characterization

| | SC (%) - | Mw | Mn | Mw/Mn |
|---|---|---|---|---|
| Acryl- | measured | (Da) | (Da) | (PDI) |
| CE(10) | 65.2 | 5094 | 2629 | 1.94 |

Three types of formulations have been prepared:
Blend Acryl-CE(10) blend with CE-GEx polyester with Desmodur as hardener (Part 1)
CE-GEx polyester alone with Tolonate HDT LV2 as hardener (0.03 wt % DBTDL) (Part 2)
CE-GEx polyester alone with Tolonate HDT LV2 as hardener (0.09 wt % DBTDL) (Part 3)

Part 1—CE-GEx Polyesters Blend with Acryl-CE(10) Formulation

TABLE 8
Clear coats, formulations
(Part 1 - CE-GEx polyesters blend with Acryl-CE(10))

| | | | | BYK 10 | DBTDL | |
|---|---|---|---|---|---|---|
| | Binder 1 | Binder 2 | HDI | wt % | 1 wt % | Thinner A |
| CE-GEx | (g) | (g) | (g) | (g) | (g) | (g) |
| GE9Hb | 71.6 | 16.9 | 31.2 | 0.63 | 1.39 | 86.33 |
| GE5b | 79.1 | 12.4 | 31.2 | 0.63 | 1.39 | 89.30 |

Binder 1: Acryl-CE(10)
Binder 2: CE-GEx polyesters

Part 2—CE-GEx Polyesters Alone, No Acryl-CE(10) Formulation (0.03 wt % DBTDL)

TABLE 9
Clear coats, formulations
(Part 2 - CE-GEx polyesters alone)

| | | | BYK | DBTDL | |
|---|---|---|---|---|---|
| | Binder 2 | HDI | 10 wt % | 1 wt % | Thinner B |
| CE-GEx | (g) | (g) | (g) | (g) | (g) |
| GE9S | 80.0 | 36.56 | 0.72 | 3.15 | 89.75 |
| GE9Ha | 80.4 | 37.27 | 0.73 | 3.20 | 87.83 |
| GE5a | 79.9 | 43.18 | 0.76 | 3.36 | 94.82 |

Part 3—CE-GEx Polyesters Alone, No Acryl-CE(10) Formulation (0.09 wt % DBTDL)

TABLE 10
Clear coats, formulations
(Part 3 - CE-GEx polyesters alone)

| | | | BYK | DBTDL | |
|---|---|---|---|---|---|
| | Binder 2 | HDI | 10 wt % | 1 wt % | Thinner B |
| CE-GEx | (g) | (g) | (g) | (g) | (g) |
| GE9Ha | 60.0 | 28.10 | 0.54 | 7.18 | 15.40 |
| GE5a | 59.8 | 32.54 | 0.57 | 7.57 | 17.79 |

### Characterization of the Clear Coats

The clearcoat formulations are applied with a barcoater on degreased Q-panel for Parts 2 & 3; sprayed for the Part 1 on Q-panel with a basecoat. The panels are dried at room temperature, optionally with a preliminary stoving at 60° C. for 30 min.

Part 1—CE-GEx Polyesters Blend with Acryl-CE(10)/Room Temperature Curing

TABLE 11
Clear coats, performances
(Part 1 - CE-GEx polyesters blend with Acryl-CE(10)

| | SC | Potlife | Drying | DFT (min) |
|---|---|---|---|---|
| CE-GEx | (%) | (h) | conditions | Cotton Balls |
| GE9Hb | 47.1 | 4.5 | RT | 15 |
| GE5b | 46.2 | 4.0 | RT | 19 |

SC: solids content, RT: room temperature

Part 2—CE-GEx Polyesters Alone, No Acryl-CE(10)/Room Temperature Curing and Room Temperature Drying after Stoving

TABLE 12
Clear coats, performances
(Part 2 - CE-GEx polyesters alone, no Acryl-CE(10)

| | | | DFT | | | |
|---|---|---|---|---|---|---|
| | | | (min) | Koenig Hardness | | |
| | SC | Drying | Cotton | (s) | | |
| CE-GEx | (%) | conditions | Balls | 6 h | 24 h | 7 d |
| GE9S | 48.4 | RT | 223 | 3 | 17 | 159 |
| GE9Ha | 49.2 | RT | 91 | 3 | 36 | 212 |
| GE5a | 49.5 | RT | 114 | 1 | 29 | 216 |
| GE9S | 48.4 | Stoving 30 min/ | Dust | 4 | 44 | 174 |
| | | 60° C. | free out | | | |
| | | | of oven | | | |
| GE9Ha | 49.2 | Stoving 30 min/ | Dust | 10 | 55 | 211 |
| | | 60° C. | free out | | | |
| | | | of oven | | | |
| GE5a | 49.5 | Stoving 30 min/ | Dust | 6 | 49 | 216 |
| | | 60° C. | free out | | | |
| | | | of oven | | | |

Part 3—CE-GEx Polyesters Alone, No Acryl-CE(10)/Room Temperature Curing and Room Temperature Drying after Stoving (0.09 wt % DBTDL)

TABLE 13
Clear coats, performances
(Part 3 - CE-GEx polyesters alone, no Acryl-CE(10))

| | | | | DFT | | | |
|---|---|---|---|---|---|---|---|
| | | | | (min) | Koenig | | |
| CE- | SC | Potlife | Drying | Cotton | Hardness (s) | | |
| GEx | (%) | (min) | conditions | Balls | 6 h | 24 h | 7 d |
| GE9Ha | 69.8 | 42.4 | RT | 47 | 3 | 66 | 193 |
| GE5a | 68.5 | 61.3 | RT | 73 | 3 | 55 | 191 |
| GE9Ha | 69.8 | 42.4 | Stoving 30 min/ | Dust | 29 | 102 | 210 |
| | | | 60° C. | free out | | | |
| | | | | of oven | | | |
| GE5a | 68.5 | 61.3 | Stoving 30 min/ | Dust | 12 | 69 | 205 |
| | | | 60° C. | free out | | | |
| | | | | of oven | | | |

### Observations

### Part 1

The potlife is about the same, the dust free time is shorter for GE9Hb vs. GE5b.

### Part 2

The 24 h hardness order GE9H, GE5 and GE9S and the dust free time at room temperature is the best for GE9H.

### Part 3

The hardness development is the best for GE9H at room temperature and heat cure, the dust free time at room temperature is quicker for GE9H than for GE5; and with a volatile organic content of 300 g/1.

### Example 14

### Monopentaerythritol/Methylhexahydrophtalic Anhydride/GE9H (1/3/2.5 Molar Ratio)=CE-GE9Hf

44.6 g amount of butylacetate, 18.0 g of monopentaerythritol, 68.0 g of methylhexahydrophthalic anhydride and 1.3 g of DBTDL 10 wt % are loaded in a glass reactor and heated to reflux until complete dissolution. Afterwards, the temperature is decreased and 75.0 g of GE9H are added over about one hour. The cooking is pursued for the time needed to decrease epoxy group content. Final acid value is 28 mg KOH/g. Application test results are indicated in Table 16.

### Example 15

### Monopentaerythritol/Methylhexahydrophtalic Anhydride/GE9H (1/3/2.5 Molar Ratio)=CE-GE9Hg

Example 14 was repeated in relatively close experimental conditions but the final acid value is 22 mg KOH/g. Application test results are indicated in Table 16.

### Example 16

### Monopentaerythritol/Methylhexahydrophtalic Anhydride/GE9H (1/3/2.5 Molar Ratio)=CE-GE9Hh

Example 14 was repeated in relatively close experimental conditions but the final acid value is 18 mg KOH/g. Application test results are indicated in Table 16.

### Example 17

### Monopentaerythritol/Methylhexahydrophtalic Anhydride/GE9H═CE-GE9Hi

Example 14 was repeated in relatively close experimental conditions but the final acid value is 5 mg KOH/g. Application test results are indicated in Table 16.

### Example 18

### Cardura™ E10 Based Acrylic Polyol Resin: Acryl-CE(10)b

300 g amount of CE10 (Cardura™ E10-glycidyl ester of Versatic acid) and 32.4 g of Xylene are loaded in a glass reactor and heated up to 157° C. Then, a mixture of monomers (86.4 g acrylic acid, 216 g hydroxyethyl methacrylate, 360 g styrene, 237.6 g methyl methacrylate), solvent (99.6 g of Xylene) and initiator (48 g Di-tert-amyl peroxide) is fed into the reactor at a constant rate in 6 hours. Then post cooking started: a mixture of 12 g Di-tert-amyl peroxide is fed into the reactor at a constant rate in 0.5 hour, then temperature maintained at about 157.5° C. for a further 0.5 hour. Finally, 504 g of n-butyl acetate is added under stirring to achieve a polyol resin with the target solids content. Test results are indicated in Table 15.

TABLE 14
Acryl-CE(10)b characterization

| | SC (%) - | Mw | Mn | Mw/Mn |
|---|---|---|---|---|
| Acryl- | measured | (Da) | (Da) | (PDI) |
| CE(10)b | 62.4 | 3142 | 2145 | 1.46 |

### Formulation and Characterization of the Clear Coats

Clearcoat formulations have been prepared as indicated in Table 17.

TABLE 15
Clear coats, formulations

| | | | | BYK 10 | DBTDL | |
|---|---|---|---|---|---|---|
| | Binder 3 | Binder 2 | HDI | wt % | 1 wt % | Thinner A |
| CE-GEx | (g) | (g) | (g) | (g) | (g) | (g) |
| GE9Hf | 72.2 | 19.4 | 34.3 | 0.65 | 1.44 | 45.8 |
| GE9Hg | 72.1 | 19.8 | 34.4 | 0.66 | 1.43 | 45.6 |
| GE9Hh | 72.1 | 19.0 | 34.6 | 0.65 | 1.44 | 45.1 |
| GE9Hi | 70.1 | 18.7 | 34.4 | 0.67 | 1.44 | 40.0 |

Binder 3: Acryl-CE(10)b from example 18
Binder 2: CE-GEx polyesters

The clearcoat formulations are sprayed on base-coated degreased Q-panel. The panels are dried at room temperature, optionally with a preliminary stoving at 60° C. for 30 min.

TABLE 16
Clear coats, performances

| | SC | Potlife | Drying | Koenig Hardness (s) |
|---|---|---|---|---|
| CE-GEx | (%) | (min) | conditions | 6 h |
| GE9Hf | 55.6 | 5.3 | RT | 1 |
| GE9Hg | 55.2 | 5.2 | RT | 2 |
| GE9Hh | 55.0 | 2.6 | RT | 4 |
| GE9Hi | 56.6 | 1.0 | RT | 7 |

### Observations:

Koenig Hardness of clearcoats is impacted by the acid value of the CE-GEx polyesters.

### Example 19

### Monopentaerythritol/Methylhexahydrophtalic Anhydride/Cardura™ E10 (1/3/3)=CE-CE10a

338.7 g amount of butylacetate, 136.6 g of Monopentaerythritol, 516.8 g of Methylhexahydrophtalic anhydride and 10 g of DBTDL 10 wt % are loaded in a glass reactor and heated to reflux until complete dissolution. Afterwards, the temperature is decreased and 718 g of Cardura™ E10 are added over about one hour. The cooking is pursued for the time needed to decrease the acid value around 24 mgKOH/g. Test results are indicated in Table 17.

### Example 20

### Monopentaerythritol/Methylhexahydrophtalic Anhydride/Cardura™ E10 (1/3/3)=CE-CE10b

338.7 g amount of butylacetate, 136.6 g of Monopentaerythritol, 516.8 g of Methylhexahydrophtalic anhydride and 10 g of DBTDL 10 wt % are loaded in a glass reactor and heated to reflux until complete dissolution. Afterwards, the temperature is decreased and 718 g of Cardura™ E10 are added over about one hour. The cooking is pursued for the time needed to decrease the acid value around 18 mgKOH/g. Test results are indicated in Table 17.

### Example 21

### Monopentaerythritol/Methylhexahydrophtalic Anhydride/Cardura™ E10 (1/3/3)=CE-CE10c

338.7 g amount of butylacetate, 136.6 g of Monopentaerythritol, 516.8 g of Methylhexahydrophtalic anhydride and 10 g of DBTDL 10 wt % are loaded in a glass reactor and heated to reflux until complete dissolution. Afterwards, the temperature is decreased and 718 g of Cardura™ E10 are added over about one hour. The cooking is pursued for the time needed to decrease the acid value around 8 mgKOH/g. Test results are indicated in Table 17.

### Example 22

### Monopentaerythritol/Methylhexahydrophtalic Anhydride/Cardura™ E10 (1/3/3)=CE-CE10d

338.7 g amount of butylacetate, 136.6 g of Monopentaerythritol, 516.8 g of Methylhexahydrophtalic anhydride and 10 g of DBTDL 10 wt % are loaded in a glass reactor and heated to reflux until complete dissolution. Afterwards, the temperature is decreased and 718 g of Cardura™ E10 are added over about one hour. The cooking is pursued for the time needed to decrease the acid value around 2 mgKOH/g. Test results are indicated in Table 17.

TABLE 17
Polyesters characterization

| | SC | Mw | Mn | Mw/Mn | Acid value |
|---|---|---|---|---|---|
| Polyester resin | (%) | (Da) | (Da) | (PDI) | (mg KOH/g) |
| CE-CE10a | 77.0 | 1230 | 1184 | 1.04 | 24.3 |
| CE-CE10b | 79.3 | 1192 | 1147 | 1.04 | 18.2 |
| CE-CE10c | 79.5 | 1197 | 1151 | 1.04 | 8.3 |
| CE-CE10d | 79.3 | 1213 | 1165 | 1.04 | 1.6 |

SC: solids content

### Formulation and Characterization of the Clear Coats

Clearcoat formulations have been prepared as indicated in Table 18.

TABLE 18
Clear coats, formulations

| | | | | BYK 10 | DBTDL | |
|---|---|---|---|---|---|---|
| CE- | Binder 4 | Binder 2 | HDI | wt % | 1 wt % | Thinner A |
| CE10x | (g) | (g) | (g) | (g) | (g) | (g) |
| CE-CE10a | 70.3 | 19.4 | 34.5 | 0.65 | 1.45 | 42.86 |
| CE- | 70.08 | 19.2 | 34.8 | 0.66 | 1.45 | 42.08 |
| CE10b | | | | | | |
| CE-CE10c | 71.2 | 18.9 | 34.7 | 0.66 | 1.45 | 42.03 |
| CE- | 70.09 | 18.90 | 34.5 | 0.65 | 1.44 | 41.98 |
| CE10d | | | | | | |

Binder 4: Acryl-CE(10)b from example 18
Binder 2: CE-CE10x polyesters

The clearcoat formulations are sprayed on base-coated degreased Q-panel. The panels are dried at room temperature, optionally with a preliminary stoving at 60° C. for 30 min. Test results are indicated in Table 19

TABLE 19
Clear coats, performances

| | | | | Koenig | | |
|---|---|---|---|---|---|---|
| | SC | Potlife | Drying | Hardness (s) | | |
| CE-GEx | (%) | (min) | conditions | 6 h | 24 h | DFT (min) |
| CE- | 54.8 | 4.6 | RT | 0 | 12 | 16 |
| CE10a | | | | | | |
| CE- | 54.8 | 4.3 | RT | 3 | 13 | 12.5 |
| CE10b | | | | | | |
| CE- | 52.3 | 1.6 | RT | 4 | 14.5 | 10.5 |
| CE10c | | | | | | |
| CE- | 48.1 | 0.9 | RT | 7 | 17 | 9.5 |
| CE10d | | | | | | |

Observations:

Koenig Hardness of clearcoats is impacted by the acid value of the CE-CE10x polyesters.

### Example 23

Maleate Diester Based Resin Prepared According to the Teaching of WO2005040241

Equipment: Glass reactor equipped with an anchor stirrer, reflux condenser and nitrogen flush.

Manufacturing Procedure of the Maleate Diester:

Maleic anhydride was reacted with the selected alcohol (3,3,5 trimethyl cyclohexanol) in an equimolar ratio at 110° C. to form a maleate monoester in presence of around 5 wt % butyl acetate. The reaction was continued until conversion of the anhydride had reached at least 90% (Conversion of the anhydride is monitored by acid-base titration.). Methanol was added to open the remaining anhydride in a 1.2/1 molar ratio of methanol/anhydride and the reaction was continued for 30 minutes.

GE9H was fed to the reactor in 30 minutes in an equimolar ratio to the remaining acid in the system whilst keeping the temperature at 110° C. The system was then allowed to react further for 1 hour at 110° C.

Manufacturing Procedure of the Maleate-Acrylic Resin (See Table 20):

The reactor was flushed with nitrogen and the initial reactor charge was heated to the polymerization temperature of 150° C. The first charge of Di ter-amylperoxide was then added in one shot. Immediately after this addition, the monomer-initiator mixture was dosed continuously to the reactor in 330 minutes at the same temperature. The monomer addition feed rate was halved during the last hour of monomer addition. After completion of the monomer addition, the third charge of Di ter-amylperoxide was then fed together with a small amount of the butyl acetate to the reactor in 15 minutes. The reactor was kept at this temperature for 60 more minutes. Finally, the polymer was cooled down. Resin characteristics are in Table 20.

TABLE 20
Composition of TMCH maleate based resin

| | | Parts by |
|---|---|---|
| | | weight |
| Initial Reactor | BuAc | 8 |
| Charge [g] | Maleate diester | 40.7 |
| Initiator start [g] | Di tert amyl peroxide | 0.4 |
| Monomer feed [g] | BuAc | 3 |
| | Hydroxyethyl methacrylate | 21.5 |
| | Styrene | 20 |
| | Methyl methacrylate | 17.8 |
| | Methacrylic Acid | 2.2 |
| | Di tert amyl peroxide | 3.6 |
| Post cooking [g] | DTAP (with 10 g BuAc) | 1 |
| Total intake [g] | | 118.2 |

TABLE 21
Resin characteristics of the TMCH maleate based resin

| | |
|---|---|
| Solids content, % | 87.5 |
| Acid value, mg KOH/g | 13 |
| Colour, Pt/Co | 35 |
| Mw | 2950 |
| Mn | 1697 |
| Mwd | 1.74 |

### Example 24

### Polyester-Ether Resin

The following constituents were charged to a reaction vessel equipped with a stirrer, a thermometer and a condenser: 456 g of GE9H, 134 g of dimethylolpropionic acid and 0.35 g of stannous octoate.

The mixture was heated to a temperature of about 110° C. for about 1 hour and then steadily increased to 150° C. in 3 hours and then cooled down. After cooling down the polyester-ether had an epoxy group content of 4 mmol/kg, a solids content of about 99% a viscosity of 254000 cP an acid value of 1.3 mg KOH/g and a theoretical OH content of 285 mg KOH/g.

This polyester-ether was then formulated in high solids and very high solids 2K polyurethane topcoats either as sole binder or as reactive diluent for an acrylic polyol.

### Example 25

### Example of Polyester Powder Prepared According to the Teaching of U.S. Pat. No. 4,145,370

250.8 g of propylene glycol, 871.5 g of terephthalic acid, 287.0 g of neopentyl glycol and 65.7 g of adipic acid were charged to a reactor together with 0.3 g of dibutyl tin oxide as catalyst. This batch was then heated to 194° C. whereupon distillation of water from the reactor commenced. The reactor temperature rose to 205° C. and the amount of water distilled over was 60.0 ml. 69.0 g of GE9H was then added and the temperature of the reactor was increased to 245° C. until the product had an acid value of 6.5 mg KOH/g. At this point the total water distilled was over 200 ml. The temperature of the batch was then reduced to 190° C. and 220.0 g of trimellitic anhydride was added. The batch was held at this temperature until the product had an acid value of 99 and was then cooled and discharged.

For the following examples the polyol dispersion was formulated in 2K waterborne polyurethane topcoats. Optionally the aqueous dispersion is made in the presence of additional other one polyol(s), or the aqueous dispersion is combined with additional other polyol dispersion(s), then formulated in 2K waterborne polyurethane topcoats.

### Example 26

### Comparative

The following constituents were charged into a reaction vessel under nitrogen flush equipped with a stirrer, a condenser and a thermometer: 100 grams of Mono PentaErythritol and 376 grams of MethylflexaHydroPhthalic Anhydride. That initial reactor charge has been heated up to 150° C. under agitation until the resulting mixture became homogenous and transparent. Then, 624 grams of Cardura™ E10 is added into the vessel. The following mixture is then added over a period of 4 hours while keeping the temperature constant: 110 grams of acrylic acid, 200 grams of Hydroxyethyl methacrylate, 400 grams of Styrene, 190 grams of Methyl methacrylate, 60 grams of Di-t-Amyl Peroxide. After further adding 10 grams of Di-t-Amyl Peroxide, a post-cooking was pursued at the same temperature for 2 hrs.

The obtained polyol has an Acid Value of about 30 mgKOH, a solids content of about 100%.

The obtained polyol was then cooled down to 80° C., and a quantity of N,N-di-methyl ethanolamine was added into the vessel to neutralized 80% of the acid groups. The vessel was stirred for another 15 minutes before starting the preparation of the aqueous dispersion.

The aqueous dispersion is obtained by adding demi water pre-heated at 70° C. gradually into the vessel over a period of 2 hours under adequate agitation. The dispersion obtained has a solid content of about 40%.

### Example 27

The following constituents were charged into a reaction vessel under nitrogen flush equipped with a stirrer, a condenser and a thermometer: 103 grams of Mono PentaErythritol and 389 grams of MethylHexaHydroPhthalic Anhydride. That initial reactor charge has been heated up to 150° C. under agitation until the resulting mixture became homogenous and transparent. Then, 608 grams of GE9H is added into the vessel. The following mixture is then added over a period of 4 hours while keeping the temperature constant: 112 grams of acrylic acid, 200 grams of Hydroxyethyl methacrylate, 400 grains of Styrene, 190 grams of Methyl methacrylate, 60 grams of Di-t-Amyl Peroxide. After further adding 10 grams of Di-t-Amyl Peroxide, a post-cooking was pursued at the same temperature for 2 hrs.

The obtained polyol has an Acid Value of about 30 mgKOH, a solids content of about 100%.

The obtained polyol was then cooled down to 80° C., and a quantity of N,N-di-methyl ethanolamine was added into the vessel to neutralized 80% of the acid groups.

The vessel was stirred for another 15 minutes before starting the preparation of the aqueous dispersion.

The aqueous dispersion is obtained by adding demi water pre-heated at 70° C. gradually into the vessel over a period of 2 hours under adequate agitation. The dispersion obtained has a solid content of about 40%.

### Example 28

### Comparative

The following constituents were charged into a reaction vessel under nitrogen flush equipped with a stirrer, a condenser and a thermometer: 103 grams of Mono PentaErythritol and 389 grams of MethylHexaHydroPhthalic Anhydride. That initial reactor charge has been heated up to 150° C. under agitation until the resulting mixture became homogenous and transparent. Then, 608 grams of GE9S is added into the vessel. The following mixture is then added over a period of 4 hours while keeping the temperature constant: 112 grams of acrylic acid, 200 grams of Hydroxyethyl methacrylate, 400 grams of Styrene, 190 grams of Methyl methacrylate, 60 grams of Di-t-Amyl Peroxide. After further adding 10 grams of Di-t-Amyl Peroxide, a post-cooking was pursued at the same temperature for 2 hrs.

The obtained polyol has an Acid Value of about 30 mgKOH, a solids content of about 100%.

The obtained polyol was then cooled down to 80° C., and a quantity of N,N-di-methyl ethanolamine was added into the vessel to neutralized 80% of the acid groups. The vessel was stirred for another 15 minutes before starting the preparation of the aqueous dispersion.

The aqueous dispersion is obtained by adding demi water pre-heated at 70° C. gradually into the vessel over a period of 2 hours under adequate agitation. The dispersion obtained has a solid content of about 40%.

1. A polyester polyol resin composition comprising a mixture of α,α-branched alkane carboxylic glycidyl esters wherein a sum of a concentration of blocked and of highly branched isomers is at least 50 wt % based on the weight of the mixture.

2. The composition of claim 1 wherein the mixture of α,α-branched alkane carboxylic glycidyl esters is based on a neononanoic (C9) acid mixture where the sum of the concentration of the blocked and of the highly branched isomers is at least 50 wt % based on the weight of the mixture.

3. The composition of claim 2 wherein the mixture of α,α-branched alkane carboxylic glycidyl esters comprises 2,2-dimethyl 3,3-dimethyl pentanoic acid glycidyl ester, 2-methyl 2-isopropyl 3-methyl butanoic acid glycidyl ester or 2-methyl 2-ethyl 3,3-dimethyl butanoic acid glycidyl ester.

4. The composition of claim 3 wherein the mixture of α,α-branched alkane carboxylic glycidyl esters comprises 2,2-dimethyl 3-methyl 4-methyl pentanoic acid glycidyl ester or 2,2-dimethyl 4,4-dimethyl pentanoic acid glycidyl ester.

5. The composition of claim 3 wherein the mixture of α,α-branched alkane carboxylic glycidyl esters comprises 2,2-dimethyl 3,3-dimethyl pentanoic acid glycidyl ester, 2 methyl 2-isopropyl 3-methyl butanoic acid glycidyl ester and 2-methyl 2-ethyl 3,3-dimethyl butanoic acid glycidyl ester in an about above 10 wt % based on the weight of the mixture.

6. The composition of claim 4 wherein the mixture of α,α-branched alkane carboxylic glycidyl esters comprises 2,2-dimethyl 3,3-dimethyl pentanoic acid glycidyl ester, 2 methyl 2-isopropyl 3-methyl butanoic acid glycidyl ester, 2-methyl 2-ethyl 3,3-dimethyl butanoic acid glycidyl ester, 2,2-dimethyl 3-methyl 4-methyl pentanoic acid glycidyl ester, 2,2-dimethyl 4,4-dimethyl pentanoic acid glycidyl ester in an amount above 40 wt % based on the weight of the mixture.

7. The composition of claim 3 wherein the mixture of α,α-branched alkane carboxylic glycidyl esters comprises 2-methyl 2-ethyl hexanoic acid glycidyl ester in an amount below 40 wt % based on the weight of the mixture.

8. A process to prepare the polyester polyol resin composition of claim 1 comprising reacting a polycarboxylic acid compound and the mixture of the α,α-branched alkane carboxylic glycidyl esters, in which the polycarboxylic acid compound is obtained by the polycondensation reaction of one or more multifunctional polyol with one or more anhydrides or acid anhydrides.

9. The process of claim 8 wherein the polyester polyol resin composition has an acid value lower than 20 mg KOH/g on solids.

10. The polyester polyol resin composition of claim 1 having a number average molecular weight (Mn) between 500 and 7000 Dalton according to a polystyrene standard, or an hydroxyl value between 40 and 320 mg KOH/g on solids.

11. A binder composition useful for a coating composition comprising the polyester polyol resin composition of claim 1.

12. A metal or plastic substrate coated with a coating composition comprising the binder composition of claim 11.

13. The binder composition of claim 11 wherein the coating composition comprises 10 to 40 weight % of aliphatic isocyanate, 5-25 weight % of the polyester polyol resin composition of claim 1, 65-40 weight % acrylic polyol, all weight % based on solid material after evaporation of the solvents.

14. The hydroxyl functional acrylic resin composition of claim 1 prepared in presence of an acrylic polyol.

15. A reaction product of a secondary alcohol and maleic anhydride which has been subsequently reacted with the hydroxyl functional acrylic resin composition of claim 1, and that can alternatively be used at 5 to 70 weight percent in an acrylic polyol copolymer resin.

16. A polyester-ether resin characterized in that it is the reaction product of the hydroxyl functional acrylic resin composition of claim 1 and dimethylol propionic acid.

17. A polyester based powder coatings composition comprising 1-20 wt % of the hydroxyl functional acrylic resin composition of claim 1 based on the weight of the coating composition.

18. The composition of claim 1 wherein the sum of the concentration of the blocked isomers and of the highly branched isomers is above 60 wt % based on the total weight of the mixture.

19. The composition of claim 1 wherein the sum of the concentration of the blocked isomers and of the highly branched isomers is above 75 wt % based on the weight of the mixture.

20. The composition of claim 2 wherein the sum of the concentration of the blocked isomers and of the highly branched isomers is above 60 wt % based on the total weight of the mixture.

21. The composition of claim 2 wherein the sum of the concentration of the blocked isomers and of the highly branched isomers is above 75 wt % based on the total weight of the mixture.

22. The composition of claim 5 wherein the mixture of α,α-branched alkane carboxylic glycidyl esters comprises 2,2-dimethyl 3,3-dimethyl pentanoic acid glycidyl ester, 2-methyl 2-isopropyl 3-methyl butanoic acid glycidyl ester and 2-methyl 2-ethyl 3,3-dimethyl butanoic acid glycidyl ester in an about above 15 wt % based on the weight of the mixture.

23. The composition of claim 5 wherein the mixture of α,α-branched alkane carboxylic glycidyl esters comprises 2,2-dimethyl 3,3-dimethyl pentanoic acid glycidyl ester, 2-methyl 2-isopropyl 3-methyl butanoic acid glycidyl ester and 2-methyl 2-ethyl 3,3-dimethyl butanoic acid glycidyl ester in an about above 25 wt % based on the weight of the mixture.

24. The composition of claim 6 wherein the mixture of α,α-branched alkane carboxylic glycidyl esters comprises 2,2-dimethyl 3,3-dimethyl pentanoic acid glycidyl ester, 2-methyl 2-isopropyl 3-methyl butanoic acid glycidyl ester, 2-methyl 2-ethyl 3,3-dimethyl butanoic acid glycidyl ester, 2,2-dimethyl 3-methyl 4-methyl pentanoic acid glycidyl ester and 2,2-dimethyl 4,4-dimethyl pentanoic acid glycidyl ester in an amount above 50 wt % based on the weight of the mixture.

25. The composition of claim 6 wherein the mixture of α,α-branched alkane carboxylic glycidyl esters comprises 2,2-dimethyl 3,3-dimethyl pentanoic acid glycidyl ester, 2-methyl 2-isopropyl 3-methyl butanoic acid glycidyl ester, 2-methyl 2-ethyl 3,3-dimethyl butanoic acid glycidyl ester, 2,2-dimethyl 3-methyl 4-methyl pentanoic acid glycidyl ester and 2,2-dimethyl 4,4-dimethyl pentanoic acid glycidyl ester in an amount above 60 wt % based on the weight of the mixture.

26. The composition of claim 7 wherein the mixture of α,α-branched alkane carboxylic glycidyl esters comprises 2-methyl 2-ethyl hexanoic acid glycidyl ester in an amount below 30 wt % based on the weight of the mixture.

27. The composition of claim 7 wherein the mixture of α,α-branched alkane carboxylic glycidyl esters comprises 2-methyl 2-ethyl hexanoic acid glycidyl ester in an amount below 20 wt % based on the weight of the mixture.

28. The process of claim 9 wherein the polyester polyol resin has an acid value lower than 10 mg KOH/g on solids.

29. The process of claim 9 wherein the polyester polyol resin has an acid value lower than 6 mg KOH/g on solids.

30. The composition of claim 1 wherein the mixture of α,α-branched alkane carboxylic glycidyl esters is derived from butene oligomers.
